(19) United States
(12) Patent Application Publication
(10) Pub. No.: US 2007/0023233 A1
(43) Pub. Date: Feb. 1, 2007

(54) Ladder support

(75) Inventor: Thomas Egli, Montreal (CA)

Correspondence Address: OGILVY RENAULT LLP (PWC), 1981 MCGILL COLLEGE AVENUE, SUITE 1600, MONTREAL, QC, H3A 2Y3, CA

(73) Assignee: IDEAL SECURITY INC.

(21) Appl. No.: 11/188,527

(22) Filed: Jul. 26, 2005

(51) Int. Cl. E06C 1/00

(52) U.S. Cl. 182/200

(57) ABSTRACT

A ladder support for supporting a ladder on a stair, step or the like. The ladder support comprising a first elongated member having a top and bottom surface and respective ends, the bottom surface at one end of the first member adapted to sit on a supporting surface and the top surface adapted to support the base of a ladder, an aperture defined at the other end of the first member through the top and bottom surfaces, a second member extending through the aperture having a freedom of motion substantially limited to a single plane intersecting the first member, fixation means securing the first and second members in an intersecting position relative to each other, and a base supporting the ladder support in a substantially upright position.

### BACKGROUND OF THE INVENTION

1. Field of the Invention

The present invention relates to a ladder support for use with a ladder.

2. Description of the Prior Art

Often times, it is necessary to employ a ladder on stairs which is a very awkward place to work from. As a result it is well known in the art to use a device for supporting a ladder on stairs, steps or the like. There exist many ladder supports in the art, however, most are either too bulky to transport and store or costly to manufacture and purchase. Although it is important for a ladder support to be sturdy and strong enough to support heavy loads, it is also desirable for a ladder support to be height adjustable and to be collapsible for transportation and storage. Many of the ladder support models on the market that can be stowed are unduly complex. Many of these models are hinged providing movement between a deployed position and a collapsed position, consequently, several parts are required that have to be carefully engineered and assembled. Ideally, the ladder support should have the least number of parts possible to simplify assembly thereof and to minimize overall manufacturing costs.

Therefore, there exists a need to provide a ladder support that addresses at least some of the issues raised above.

### SUMMARY OF THE INVENTION

It is therefore an aim of the present invention to provide a ladder support that is simple in construction.

It is also an aim of the present invention to provide a ladder support that is inexpensive to manufacture and easy to store.

Therefore, in accordance with the present invention a ladder support comprising a first elongated member having a top and bottom surface and respective ends, the bottom surface at one end of the first member adapted to sit on a supporting surface and the top surface adapted to support the base of a ladder, an aperture defined at the other end of the first member through the top and bottom surfaces, a second member extending through the aperture having a freedom of motion substantially limited to a single plane intersecting the first member, fixation means securing the first and second members in an intersecting position relative to each other, and a base supporting the ladder support in a substantially upright position.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is a perspective view of a ladder support in accordance with a preferred embodiment of the present invention, the ladder support resting on a stair and supporting the base of a ladder;

FIG. 2 is a perspective view of the ladder support of FIG. 1, in a collapsed position;

FIG. 3 is an exploded view of the ladder support of FIG. 1, showing 3-dimensional orientation thereof;

FIG. 4 is a side sectional view taken along cross section lines A-A of FIG. 1 showing a horizontal member of the ladder support; and

FIG. 5 is a perspective view of a pin shown in FIG. 3.

### DESCRIPTION OF THE PREFERRED EMBODIMENTS

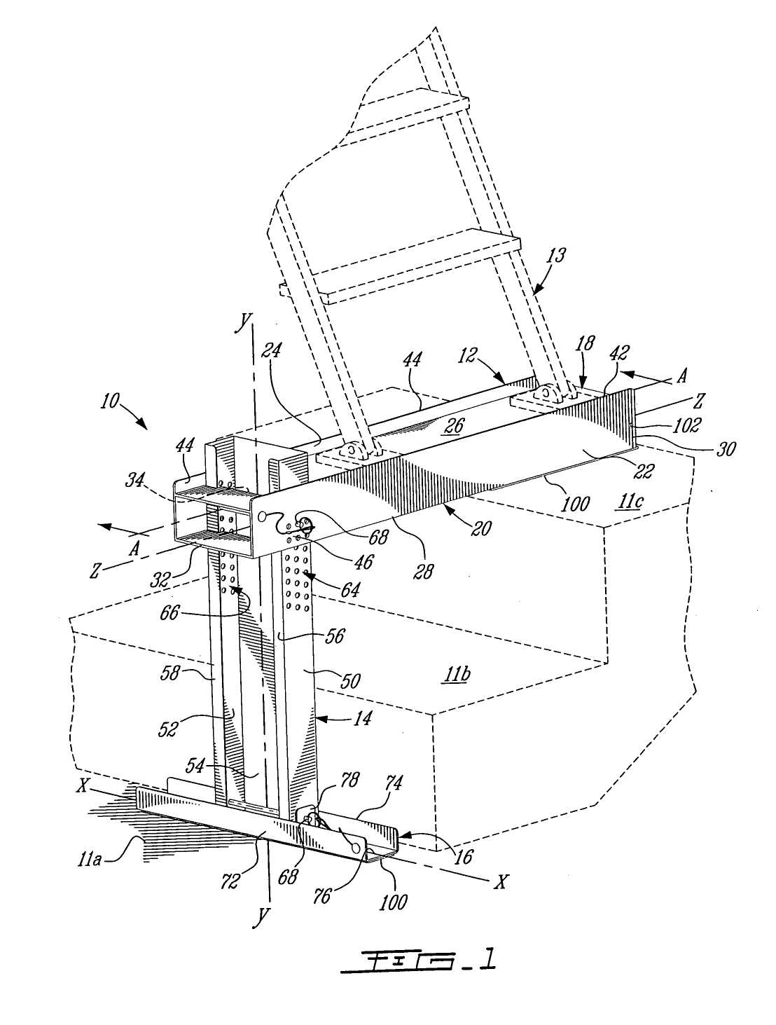

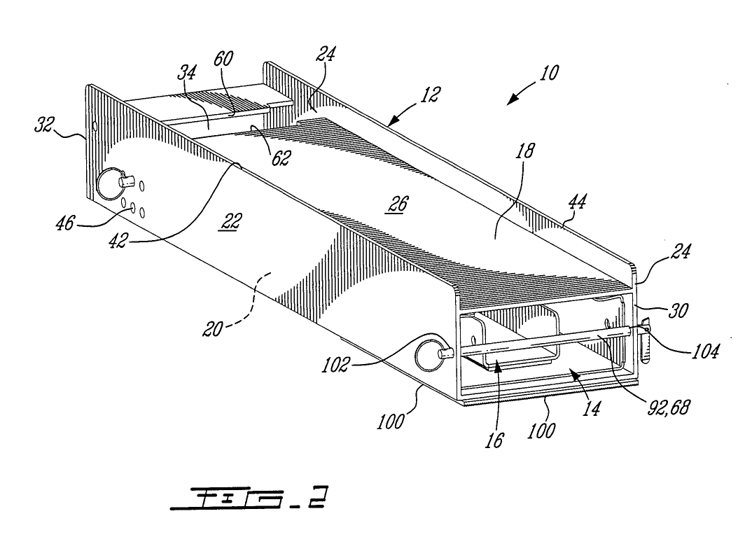

FIGS. 1 and 2 illustrate a ladder support, indicated by reference numeral 10, in a deployed and in a collapsed configuration respectively in accordance with a preferred embodiment of the present invention. The ladder support 10 in the deployed position is adapted to rest on a stair, step or the like, indicated by reference numeral 11 in FIG. 1, to support the base of a ladder 13. The ladder support 10 in the collapsed position can be packed for transportation and storage. Advantageously, the ladder support 10 exemplified in FIG. 2 can be telescopically stowed such that the components thereof can all fit one within the other allowing the ladder support 10 to fold up into a compact assembly.

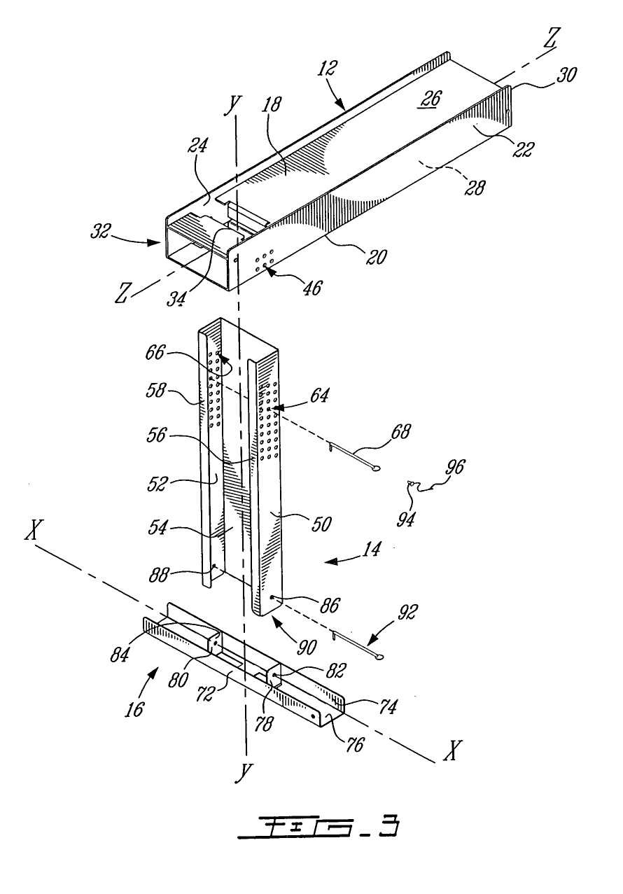

Now referring concurrently to FIGS. 1 and 3, the ladder support 10 comprises first and second members 12 and 14 respectively and a base 16. The first and second members 12 and 14 and the base 16 have an elongated shape and are adapted for assembly in a 3-dimensional x-y-z coordinate axis configuration as illustrated in FIG. 3. Preferably, the base 16 is adapted for alignment along the x-axis, the second member 14 along the y-axis, and the first member 12 along the z-axis so as to promote 3-dimensional stability. It can be seen that the first and second members 12 and 14 intersect at a right angle such that the first member 12 is adapted for horizontal placement and the second member is adapted for vertical placement. The second member 14 and the base 16 also intersect at a right angle. Notably, it should be understood that the angular orientation of the first and second member and the base 12, 14 and 16 respectively can be varied in the Cartesian planes without departing from the scope of the present invention. The base 16 would be placed on a step or landing 11a of the stairs while the end 30 would rest on a higher step 11d.

Referring concurrently to FIGS. 2 to 4, the first elongated member 12 preferably has a rectangular box-shape defined by four walls: a top wall 18, a bottom wall 20, and two lateral sides 22 and 24 respectively joined at right angles. The top and bottom walls 18 and 20 define top and bottom surfaces 26 and 28 respectively which are in parallel relationship to each other. At one end 30 of the first member 12 the bottom surface 28 is adapted to sit on a step 11d and the top surface 26 is adapted to support the base of a ladder 13. At the other end 32 of the first member 12 an aperture 34 is defined through the top and bottom walls 18, 20.

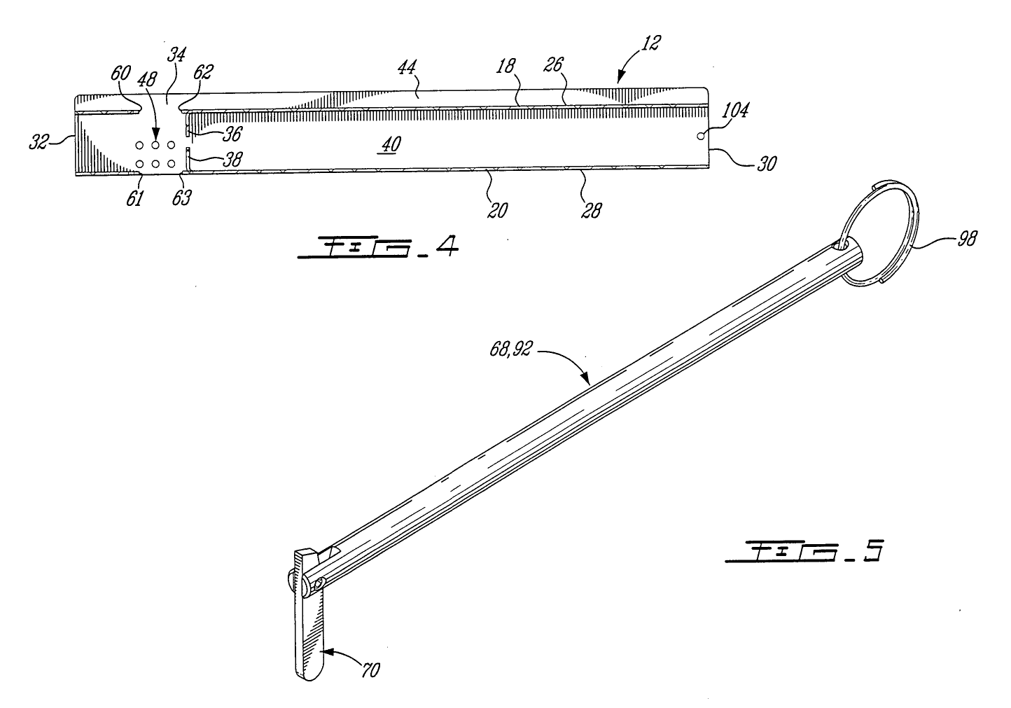

As shown in FIG. 4, adjacent the aperture 34 are top and bottom projections 36 and 38 extending respectively away from the top and bottom walls 18 and 20 towards each other. Preferably, the top and bottom projections 36 and 38 extend perpendicular to the top and bottom walls 18 and 20 forming a substantially closed end of an axial cavity 40 defined within the confines of the walls 18, 20, and sides 22 and 24 of the first member 12. The opening to the cavity 40 is defined at end 30 of the first member 12. As will be clarified further, the cavity 40 enables the ladder support 10 to be telescopically stowed. Thus, the top and bottom projections 36 and 38 act as an abutment in the cavity 40 limiting the axial distance by which parts of the ladder support 10 can be inserted into the cavity 40 of the first member 12.

Referring the FIGS. 3 and 4, the first member 12 is exemplified with the lateral sides 22 and 24 thereof having flanges 42 and 44 respectively projecting above the top surface 26. This feature is advantageous in preventing the base of the ladder 13 from sliding off the top surface 26. Thus, in the case where the ladder 13 is resting against the wall of a staircase, the base of the ladder 13 may rest upon the top surface 26 and will be confined thereon by the flanges 42 and 44.

The lateral sides 22 and 24 of the first member 12 each have a plurality of holes 46 and 48 respectively that are in alignment with each other. The holes 46 and 48 are illustrated in rows and columns, specifically two rows of three holes, but of course only one hole on each lateral side in alignment would suffice. The holes 46 and 48 are a part of the fixation means that enable the first member 12 to be fixed in position relative to the second member 14 as will be further explained in detail. However, the holes 46 and 48 are only one form of fixation means that can be employed.

The preferred material for the first member 12 is an aluminium alloy with a plain finish, but other similar materials can also be used.

Referring concurrently to FIGS. 1 and 3, when the ladder support 10 is in the deployed position the second member 14 extends through the aperture 34 of the first member 12 having a freedom of motion substantially limited to a single axis parallel to the y axis which intersects a horizontal plane parallel to the z-axis in which is positioned the first member 12. Thus, the second member 14 is limited to an up and down motion in the y-axis as it is restricted by the boundaries of the aperture 34. The ladder support 10, of the present invention, could be designed with the second member 14 intersecting the first member 12 at another angle such that it would be inclined with respect thereto. It should be understood that in such a case the base 16 would also have to be designed accordingly so as to ensure the functionality of the ladder support 10.

More specifically, the second elongated member 14 is adapted to be inserted through the aperture 34 such that it is restricted to one dimension of freedom in that it cannot pivot nor rotate relative to the first member 12. The second member 14 has a C-shaped configuration defined by two lateral sides 50 and 52 and a web 54 joined at right angles. In this embodiment the lateral sides 50 and 52 also have inwardly extending flanges 56 and 58 respectively. As shown in FIGS. 3 and 4 the flanges 56, 58 and the web 54 of the second member 14 engage abutting edges 60 and 62 respectively of the top wall 18 and abutting edges 61 and 63 of the bottom wall 20 of the first member 12 to allow for restrained guidance when the second member 14 is slid through the aperture 34.

The lateral sides 50 and 52 of the second member 14 include a plurality of holes 64 and 66 respectively that are in alignment with each other. The holes 64 and 66 are disposed on the lateral sides 50 and 52 in similar formation as holes 46 and 48 so as to be aligned therewith when the second member 14 extends through the aperture 34. The number of rows of holes 64 and 66 provided on the second member 14 determines the height adjustment of the ladder support 10. The greater the number of holes in a vertical array, the greater the range of height adjustment.

The preferred material for the second member 14 is cold rolled steel with a zinc plated finish, but other similar materials can also be used.

Now referring concurrently to FIGS. 3 and 5, once the first and second members 12, 14 are mounted together and their respective holes 46,48 and 64,66 are aligned, a pin 68 is inserted through one set of aligned holes to fix the relative position therebetween. The pin 68 is inserted at a right angle to the lateral sides of the first and second members 22, 24, 50, 52. The set of aligned holes chosen to receive the pin 68 depends on the height required for the ladder support 10.

As shown in FIG. 5, the pin 68 has a pivoting tip 70. The pivoting tip 70 retains the pin 68 in position preventing it from retracting out of the set of aligned holes. It should be understood that the pin-hole type of fixation means is merely one example applicable to the present invention.

Now referring back to FIG. 3, the base 16 is illustrated as having a generally channel shaped configuration defined by two upstanding side walls 72 and 74 and a bottom web 76 joined at right angles. Also extending upwardly from the bottom web 76 is a pair of rectangular plates 78 and 80 for engagement with the second member 14 when the latter is mounted onto the base 16. More specifically the rectangular plates 78 and 80 are included within the confines of respective lateral sides 50 and 52 of the second member 14 adjacent thereto. Furthermore, it can be seen in FIG. 3 that the pair of rectangular plates 78 and 80 define a pair of aligned holes 82 and 84 that align with a pair of holes 86 and 88 defined in the lateral sides 50 and 52 at bottom end 90 of the second member 14. A pin 92 similar to pin 68 is inserted through the aligned holes 82, 84, 86 and 88. Again, it should be understood that other fixation means exist that are commonly known in the art.

The base 16 helps maintain the second member 14 in a standing position supporting the ladder support 10 in a substantially up-right position. Nevertheless, the ladder support 10 is designed to rest against a supporting surface and is not required to be perfectly stable when only supported by the base 16.

The preferred material for the base 16 is cold rolled steel with a zinc plated finish, but other similar materials can also be used.

Furthermore, the pins 68 and 92 of this preferred embodiment may be secured to the first member 12 and the base 16 respectively by way of a press-lock rivet 94 and lanyard 96 as can be seen in FIGS. 1 and 3. The lanyard 96 in attached to a ring 98 disposed at one end of the pins 68 and 92. The lanyard 96 is attached to. the rivet 94 which in turn is press-locked into position. This feature is advantageous in avoiding the loss of the pins 68 and 92.

Referring to FIGS. 1, 2 or 3, in the preferred embodiment, the ladder support 10 of the present invention is provided with anti-skid pads 100 on the bottom surface 28 of the first member 12 and underneath the bottom web 76 of the base 16. The anti-skid pads promote better grip between the bottom surface 28 and the supporting surface (not shown) as well as between the ground and the base 16. The anti-skid pads 100 may be provided with downward facing grooves (not shown) to optimize performance thereof. Preferably the anti-skid pads 100 are made of rubber.

Now referring to FIGS. 2, 3 and 4, in order to collapse the ladder support 10, the pins 92 and 68 need only be retracted and the first and second members 12, 14 and base 16 separated. Once collapsed, the ladder support 10 exemplified can be telescopically stowed by inserting the second member 14 into the axial cavity 40 of the first member 12 by way of the opening at end 30 thereof. Similarly, the base 16 can be inserted axially through the second member 14 into the cavity 40. One of the pins 68 and 92 can be inserted through a pair of aligned holes 102 and 104 at end 30 of the first member 12 to prevent the second member 14 and the base 16 from sliding out of the cavity 40. Therefore, the ladder support 10 is reduced to the size of the first member 12 which is advantageous for transportation and storage thereof.

The ladder support of the present invention provides many advantages over prior art designs. One of these advantages being that it is simple in construction and therefore easy to assemble and disassemble. Its simplicity arises from the utilization of only three main parts mounted together in a unique manner. The insertion of the second member 14 through the aperture 34 of the first member 12 is effective in limiting the movement of both members relative to each other all while providing a simple overall design. The design also allows for height adjustment which is an added benefit. Furthermore, the ladder support of the present invention is collapsible allowing it to be easily transported and stored. Finally, the ladder support of the present invention is inexpensive to manufacture due to the limited number of parts and also that the parts can be stamped.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A ladder support comprising a first elongated member having a top and bottom surface and respective ends, the bottom surface at one end of the first member adapted to sit on a supporting surface and the top surface adapted to support the base of a ladder, an aperture defined at the other end of the first member through the top and bottom surfaces, a second member extending through the aperture having a freedom of movement substantially limited to a single axis intersecting the first member, fixation means securing the first and second members in an intersecting position relative to each other, and a base supporting the ladder support in a substantially upright position.

2. The ladder support as defined in claim 1 wherein, the first and second members and the base are positioned in a 3-dimensional x-y-z coordinate axis configuration.

3. The ladder support as defined in claim 2 wherein, the base is aligned along the x-axis, the second member along the y-axis, and the first member along the z-axis in a 3-dimensional configuration.

4. The ladder support as defined in claim 1 wherein, the position between the first and second member is adjustable to vary the height of the ladder support.

5. The ladder support as defined in claim 1 wherein, the intersecting position between the first and second members is at a substantially right angle.

6. The ladder support as defined in claim 1 wherein, the second member is limited to a freedom of movement in an axis normal to the first member.

7. The ladder support as defined in claim 1 wherein, the ladder support is collapsible for storage.

8. The ladder support as defined in claim 7 wherein the first elongated member is box shaped including parallel sides, top and bottom walls defining a cavity and the second member is separable from the base and has a shape that permits the second member to be stowed in the first elongated member while the base can be inserted into the cavity with the second member so that the ladder support can be telescopically stowed.

9. The ladder support as defined in claim 1 wherein, the fixation means include aligned holes in both the first and the second members for receiving a pin therethrough.

10. A ladder support comprising a first and a second member fixed in a substantially right angled position relative to each other when in a deployed configuration, the first member defining an aperture for receiving the second member therethrough, the second member having a base for supporting the ladder support in a substantially upright position.

11. The ladder support as defined in claim 10 wherein, the first and second members and the base are positioned in a 3-dimensional x-y-z coordinate axis configuration.

12. A ladder support comprising a first member having a top and bottom surface and respective ends, the bottom surface at one end of the first member adapted to sit on a supporting surface and the top surface adapted to support the base of a ladder, an aperture defined at the other end of the first member through the top and bottom surfaces, a second member extending through the aperture fixed in a relative position to the first member, a base supporting the ladder support in a substantially upright position, the first and second members and the base positioned in a 3-dimensional x-y-z coordinate axis configuration.
